(19) United States
(12) Patent Application Publication
(10) Pub. No.: US 2012/0078995 A1
(43) Pub. Date: Mar. 29, 2012

(54) SYSTEM AND METHOD FOR WARMING AN OPTIMIZATION DEVICE

(75) Inventors: Nitin Jain, San Jose, CA (US); Nandan Tammineedi, Los Gatos, CA (US); Gabriel Levy, Oakland, CA (US); Prashant Murthy, Santa Clara, CA (US); Charles Fraleigh, Sunnyvale, CA (US); Sumanth Sukumar, San Francisco, CA (US); Guy Messalem, Stanford, CA (US); Zhen Xue, San Jose, CA (US)

(73) Assignee: RIVERBED TECHNOLOGY, INC., San Francisco, CA (US)

(21) Appl. No.: 12/893,894

(22) Filed: Sep. 29, 2010

(51) Int. Cl. G06F 15/16

(52) U.S. Cl. 709/202; 709/246

(57) ABSTRACT

A system and method are provided for warming a network intermediary (e.g., a proxy, a transaction accelerator) to enable it to provide effective optimization (e.g., data reduction) without a cold start. When a pair of network intermediaries cooperate to optimize a communication connection (e.g., between a client and a server), either or both intermediaries may form branch channels with one or more peers. Via these branch channels, the intermediaries may forward optimization information such as data references received from the other intermediary (i.e., in place of data segments, as part of a data reduction scheme), and/or resolve unknown references.

### FIELD

The present invention relates to optimization of network communications, and in particular to a system and method for using optimized communications between two devices to warm a third device for optimizing another connection.

### BACKGROUND

A network is typically used for data transport among devices distributed over the network. Some networks are considered “local area networks” (LANs), and others are considered “wide area networks” (WANs), although not all networks are so categorized and others might have characteristics of both LANs and WANs. Often, a LAN comprises nodes that are all controlled by a single organization and that are connected over dedicated, relatively reliable and physically short connections. An example might be a network in an office building for one company or division.

By contrast, often a WAN comprises nodes over which many different organizations' data flow, and might involve physically long connections. In one example, a LAN might be coupled to a global internetwork of networks referred to as the “Internet,” such that traffic from one node on the LAN passes through the Internet to a remote LAN and then to a node on that remote LAN.

Data transport is often organized into “transactions”, wherein a device at one network node initiates a request for data from another device at another network node and the first device receives the data in a response from the other device. By convention, the initiator of a transaction is referred to herein as the “client” and the responder to the request from the client is referred to herein as the “server”.

Typically, the client sends one or more requests over that network channel via a set of networking protocols, and the requests are processed by the server, which returns responses. Many protocols are connection-based, whereby the two cooperating entities (sometimes known as “hosts”) negotiate a communication session to begin the information exchange.

In setting up and maintaining a communication session, the client and the server might each maintain state information for the session, which may include information about the capabilities of each other. At some level, the session forms what is considered a “connection” between the client and the server. Once the connection is established, communication between the client and the server can proceed using state from the session establishment and other information to send messages between the client and the server.

A message is a set of data comprising a plurality of bits in a sequence, possibly packaged as one or more packets according to the underlying network protocol(s). Once the client and the server agree that the session is over, each side typically disposes of the state information for that transaction, other than possibly saving log information.

Thus, to enable networking transactions, computing hosts make use of a set of networking protocols to exchange information between the two hosts. Many networking protocols have been designed and deployed, with varying characteristics and capabilities. The Internet Protocol (IP), Transmission Control Protocol (TCP), and User Datagram Protocol (UDP) are three examples of protocols that are in common use today. Various other networking protocols might also be used.

Since protocols evolve over time, a common design goal is to allow for future modifications and enhancements of the protocol to be deployed in some entities, while still allowing those entities to interoperate with hosts that are not enabled to handle the new modifications. One simple method of promoting interoperability involves protocol version negotiation. In an example of a protocol version negotiation, one entity informs the other entity of the capabilities that the first entity embodies. The other entity can respond with the capabilities that the other entity embodies. Through this negotiation, each side can be made aware of the capabilities of the other, and the channel communication can proceed with this shared knowledge.

For protocol version negotiation to be effective, if one entity advertises a capability that the other entity does not understand, the second entity should still be able to handle the connection. This method is used in both the IP and TCP protocols—each provides a mechanism by which a variable length set of options can be conveyed in a message. The specification for each protocol dictates that if one entity does not support a given option, it should ignore that option when processing the message. Other protocols may have similar features that allow for messages to contain data that is understood by some receivers of the data but possibly not understood by other receivers of the data, wherein a receiver that does not understand the data will not fail in its task and will typically forward the not understood data such that another entity in the path will receive that data.

A message from a client to a server, or vice versa, traverses one or more network “paths” connecting the client and server. A basic path would be a physical cable connecting the two hosts. Typically, however, a path involves a plurality of physical communication links and intermediate devices (e.g., routers) that are able to transmit a packet along a path to the server, and transmit response packets from the server back to the client. These intermediate devices typically do not modify the contents of a data packet; they simply forward the packet in the correct direction. However, it is possible that a device that is in the network path between a client and a server could modify a data packet along the way. To avoid violating the semantics of the networking protocols, any such modifications should not alter how the packet is eventually processed by the destination host.

A related concept is that of a network proxy. A network proxy is a transport level or application level entity that functions as a performance-enhancing intermediary between a client and a server. In this case, a proxy may act as the terminating point for the client's connection with the server, and initiate another connection to the server on behalf of the client. Alternatively, the proxy may connect to one or more other proxies that in turn connect to the server.

Each proxy may forward, modify, or otherwise transform transactions as they flow from the client to the server, and vice versa. Examples of proxies include Web proxies that enhance performance through caching or that enhance security by controlling access to servers, mail relays that forward mail from a client to another mail server, DNS relays that cache DNS name resolutions, and so forth.

In some circumstances, a proxy may operate transparently to the client. The presence of a transparent proxy is not made known to the client, and so all client requests proceed along the network path towards the server as they would have if the transparent proxy were not present. Illustratively, this might be done by placing the transparent proxy host in the network path between the client and the server.

A switch may be employed so the proxy host can intercept client connections and handle the requests via the proxy. For example, the switch could be configured so that all Web connections (i.e., TCP connections on port 80) are routed to a local proxy process. The local proxy process can then perform operations on behalf of the server.

Realization of some benefits of a transparent proxy requires that a proxy pair exist in the network path. In particular, if a proxy is used to transform a message or communication data in some way, a second proxy preferably untransforms the data. For example, where traffic between a client and a server is to be compressed, encrypted or otherwise optimized for transport over a portion of the network path between the client and the server, a proxy on one side of that portion would perform the optimization on the data before it flows over that portion, and a proxy on the other side of that portion would uncompress, decrypt or otherwise retrieve the data and forward it along the network path, thereby providing for transparent transformation of data flowing between the client and the server.

Actions that require a proxy pair (e.g., compression and decompression, encryption and decryption) generally are not performed unless each of the proxies can be assured of the existence and operation of the other proxy in the proxy pair. Even where a given proxy is interposed in a network and handles all of the traffic for a given client or server, it still must discover the other member for each proxy pair the given proxy needs, if that proxy is to perform actions that require proxy pairs (e.g., optimization).

In today's computing environments, a client application or device (e.g., a portable computer) that benefits from optimized client-server communications may at different times connect to a server via different network paths and, therefore, different proxy pairs. For example, when a client device is operated within a branch office or other relatively static portion of organization's network, it may connect via a proxy located within that office.

When the device is operated outside that office, however, it may connect via a different proxy, or may even have a resident proxy application that operates when the device is used away from the organization's physical network. Although this resident proxy may be present when the device operates within the office, it may or may not operate as a proxy at such times, and may instead defer to the proxy located within the branch office.

A given proxy pair often hosts multiple distinct communication connections. For example, a proxy pair comprising a proxy in an organization's branch office and a proxy in the organization's central data center may host virtually all client-server connections between the branch office and the data center. Therefore, it may be desirable or even necessary to reduce the amount of data communicated across a proxy pair.

In general, data stored and communicated across enterprise systems and networks often possesses a high degree of redundancy. For example, electronic mail messages and attachments sent to large numbers of recipients in an organization generate many copies of the message in storage systems, and cause redundant traffic to be sent across the organization's network. Likewise, many electronic documents within an organization share high degrees of commonality as different employees work with similar pieces of information in different settings or for different purposes.

Data reduction allows a set of data to be transmitted across a communication link to be represented with fewer bytes than the entire set of data comprises, and is useful for reducing the amount of traffic traversing that link. Illustratively, a wide area network (WAN), such as the Internet, generally has less free bandwidth available for a given connection than a network dedicated to an organization, such as an intranet or a local area network (LAN). Therefore, reducing the amount of data dispatched across the WAN may reduce overall bandwidth usage.

Data reduction is a process of replacing input data, for the purpose of transmission, with a reference that will be understood to represent the input data. A reference generally comprises fewer bits or symbols than the input data it replaces. Thus, one member of a proxy pair may replace a particular sequence of input data with a specific reference or symbol; the cooperating proxy will recognize the symbol and replace it with the corresponding input data. Data reduction thus allows for more efficient transmission of data, as fewer bits need to be sent to allow a receiver to recover the original set of bits (exactly or approximately), and can also allow for more efficient storage because fewer bits need be stored.

In existing data reduction schemes, a cooperating pair of proxies maintains local datastores of references for representing sequences of input data. Their datastores are specific to those proxies, and are not usable by other proxies. Therefore, each time a new proxy pair is established, the proxies perform a “cold start” and steadily populate their datastores over time.

A cold start signifies that the proxies begin hosting their communication connection with few or no references to use for data reduction. Until they have interacted enough to form a robust datastore, their data reduction capability is limited.

Therefore, each time a device (e.g., a client computer) commences operation through a different proxy pair than that with which it previously operated (e.g., from a different location), it may encounter a cold start as the operative proxy pair assembles its data (e.g., symbol dictionary) to be used to optimize communications. This is particularly true for a resident proxy application (e.g., a proxy application that executes on a mobile client device).

### SUMMARY

In some embodiments of the invention, systems and methods are provided for warming or pre-warming a network intermediary (e.g., a proxy, a transaction accelerator) for optimizing a communication connection, particularly a connection in which data reduction will be applied. The network intermediary is warmed using information from an optimized communication connection between two other network intermediaries.

In these embodiments, when a pair of network intermediaries cooperates to optimize a communication connection (e.g., between a client and a server), either or both intermediaries form separate branch channels with one or more peers. Via these branch channels, the intermediaries may warm those peers by forwarding optimization information—such as references received from the other intermediary, data segments corresponding to those references, etc.

When a data reduction scheme is applied to an optimized connection, references are transmitted across the network, between the participating intermediaries, in place of data segments. To warm a peer to prepare it to provide effective data reduction, a participating intermediary forwards a reference to a peer, and the corresponding data segment if necessary, to help the peer maintain a datastore that can quickly be used to effectively optimize another connection.

After multiple intermediaries have established a peer relationship, a remote intermediary participating with one of those peers in an optimized communication connection can send to the participating peer a data reference that is not already known to that intermediary, as long as it is known to another peer, because the participating peer intermediary can resolve the reference with the other peer.

### DESCRIPTION OF THE FIGURES

FIG. 1 is a block diagram depicting a computing environment in which a network intermediary is pre-warmed to prepare it for optimization of a future communication connection, according to some embodiments of the invention.

FIG. 2 is a block diagram demonstrating the sharing of optimization information between network intermediaries, according to some embodiments of the invention.

FIG. 3 is a time sequence diagram demonstrating a handshaking process for establishing a client-server communication connection in which a network intermediary not participating in the connection can be warmed, according to some embodiments of the invention.

FIG. 4 is a flow chart demonstrating a method of configuring a communication environment to support warming of a network intermediary to enable it to provide an effective level of optimization without a cold start, according to some embodiments of the invention.

FIGS. 5 and 6 are flow charts demonstrating how a network intermediary may be warmed during optimization of a communication connection, and how a warmed intermediary can be leveraged to reduce the amount of data transmitted across a network, according to some embodiments of the invention.

FIG. 7 is a block diagram of hardware apparatus that may be employed to optimize a communication connection and to warm another apparatus to optimize another connection, and/or that may be warmed by the other apparatus when it optimizes the other connection, according to some embodiments of the invention.

FIG. 8 is a block diagram of a network intermediary that may be employed to facilitate establishment of a secure split-terminated client-server connection with certificate-based authentication of a client, according to some embodiments of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In some embodiments of the invention, systems and methods are provided for pre-warming a network intermediary device (e.g., a proxy) to prepare it for optimizing another communication connection. Specifically, information used or generated during optimization of a current communication connection by a pair of network intermediaries is provided to a third network intermediary. That information may be used by the third network intermediary in a parallel connection and/or a future connection.

Illustratively, the optimization comprises data reduction, compression/decompression, encryption/decryption, and/or some other scheme. Thus, the optimization information may comprise references, data segments, cryptographic keys, etc.

Providing the optimization information to the third network intermediary may be seen as warming or pre-warming that intermediary so that it can immediately provide an efficient or effective level of optimization to another connection. For example, if the optimization comprises data reduction, pre-warming the network intermediary provides it with a datastore of references to use immediately with a new communication connection, even if that connection requires the intermediary to form a new proxy pair with another intermediary.

When a pair of proxies cooperates to perform data reduction on a client-server communication connection—one on a client side and one on a server side—the server-side proxy can use a particular reference (in place of the corresponding data segment), as long as a peer of the client-side proxy knows the reference and the client-side proxy has a channel open with that peer. The client-side proxy can retrieve the segment from the peer, if necessary, instead of from the server-side proxy. By sharing new references among the client-side proxy's peers, those peers are warmed and can quickly provide effective data reduction for a new communication connection.

As one of ordinary skill in the art will appreciate, traditionally, only two devices actually performing optimization for a client-server communication connection (e.g., members of a proxy pair) would retain or have access to information regarding the optimization, including artifacts such as references and data segments. That information would not be shared with a proxy that does not participate in the optimization.

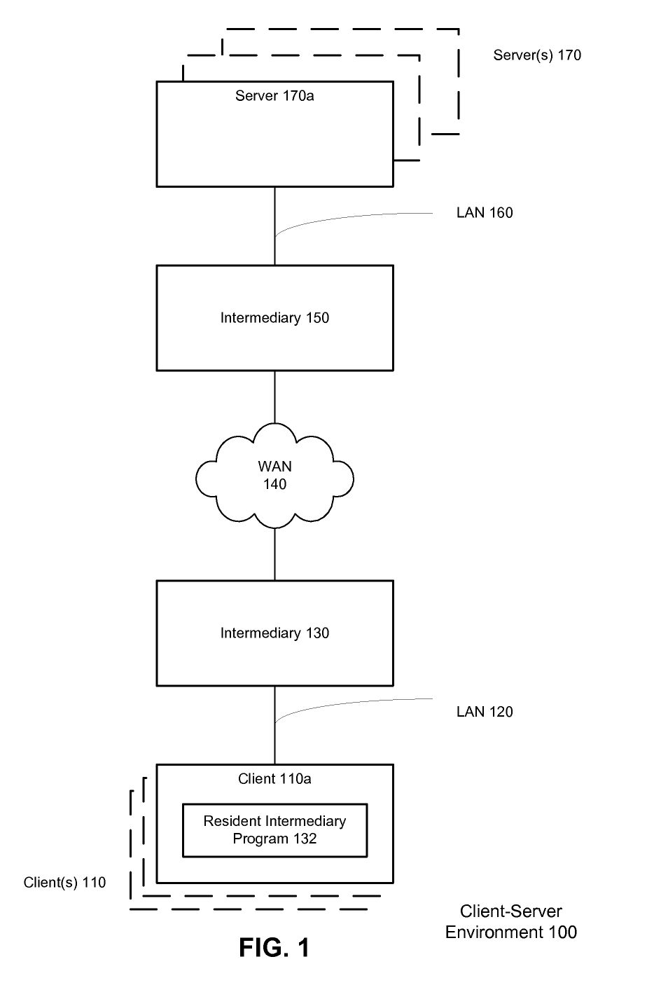

FIG. 1 illustrates client-server environment 100 in which some embodiments of the invention may be implemented. In this environment, clients 110 (e.g., client 110a) communicate with servers 170 (e.g., server 170a) in client-server connections established via one or more operative communication protocols of the intervening networks. Client 110a may comprise a computing device that is portable (e.g., a laptop or notebook computer, a netbook) or relatively stationary (e.g., a desktop, a workstation).

Intermediaries (or, alternatively, proxies) 130, 150 are situated in a path of communication between client 110a and server 170a. In some alternative embodiments of the invention, one or more of intermediaries 130, 150 may not be in a direct path of client-server communications.

Intermediaries 130, 150 are coupled via WAN (Wide Area Network) 140, while client 110a is coupled to intermediary 130 via LAN (Local Area Network) 120 and server 170a is coupled to intermediary 150 via LAN 160. In the environment depicted in FIG. 1, communications traversing WAN 140 are characterized by relatively high latency and low bandwidth in comparison to communications transiting LANs 120, 160. In other embodiments of the invention, other types of wired and/or wireless communication links may be employed. For example, LAN 120 and/or LAN 160 may be WANs, a LAN may be a point-to-point link or a WAN, etc.

In client-server environment 100, intermediary 130 is relatively local to client 110a, while intermediary 150 is relatively local to server 170a (e.g., within the same data center). Therefore, intermediary 130 may be termed a “client-side intermediary” (or CSI) and intermediary 150 may be termed a “server-side intermediary” (or SSI) to reflect their relative positions within environment 100. Although not shown in FIG. 1, additional client side intermediaries may also cooperate with server-side intermediary 150, and/or client-side intermediary 130 may cooperate with other server-side intermediaries.

Resident intermediary program 132 comprises a client-side intermediary installed as an application program on client 110a. Reference to a client-side intermediary herein should be interpreted so as to encompass intermediary 130 and/or resident intermediary programs 132, as appropriate.

When client 110a participates in an optimizable client-server connection with server 170a while coupled to intermediary 130, either of intermediary 130 and intermediary program 132 may form a proxy pair with intermediary 150 to optimize the connection. When client 110a participates in an optimizable connection without being coupled to CSI 130, the proxy pair used to optimize the connection may comprise intermediary program 132 and SSI 150.

In one particular embodiment of the invention, intermediaries 130, 132, 150 are Steelhead™ transaction accelerators from Riverbed® Technology, and are configured to optimize communications and applications through compression, data reduction and/or other means. Transaction accelerators are referred to in the art by many different terms, including, but not limited to, wide area network (WAN) accelerators, WAN optimizers, WAN optimization controllers (WOCs), wide-area data services (WDS) appliances, WAN traffic optimizers (WTOs), and protocol accelerators or optimizers. In other embodiments, the intermediaries may be configured to perform other operations in addition to or instead of optimization, such as routing, caching, etc.

All communication traffic between client 110a and server 170a may traverse a particular pair of intermediaries for any period of time, such as intermediaries 130, 150 or intermediaries 132, 150. One or both of these intermediaries may also handle traffic between client 110a and servers other than server 170a, and/or between server 170a and other clients. In other embodiments, a client-server connection may utilize other communication paths that avoid one or more of the illustrated intermediaries.

As described above, client device 110a may sometimes operate coupled to intermediary 130 (e.g., within an organization's branch office), and at other times may operate without a connection to intermediary 130, but with the assistance of intermediary program 132 (e.g., as part of a VPN or Virtual Private Network). In either case, a client-server connection established with server 170a will involve a proxy pair established between SSI 150 and a suitable CSI.

In embodiments of the invention, information or metadata produced or used in the optimization (e.g., data references or symbols, encryption keys) are shared between client-side intermediaries 130, 132, and possibly other CSIs. Thus, whenever one of them is actively optimizing a client-server connection between client 110a and a server 170, that CSI will share optimization information with the other. As a result, the other client-side intermediary is always prepared to optimize a new connection without a “cold start”. Instead, it may make a “warm start” and immediately apply the optimization information it received before the connection.

In some specific implementations, optimization between a client 110 and a server comprises data reduction. In these implementations, a CSI 130, 132 actively optimizing the client-server connection in cooperation with SSI 150 forwards new references it receives (or generates) to the other CSI, and the corresponding data segments as necessary. The other CSI can then quickly provide effective data reduction if it is activated to support a different optimized connection. Also, the server-side intermediary knows that after using a new reference with one of the peer CSIs, it can use that reference with another peer and allow that other peer to interact with the first peer to resolve the reference to the corresponding data segment.

Further, if the same client 110 transitions from a client-server connection optimized by SSI 150 and one of the CSIs 130, 132 to another client-server connection optimized by SSI 150 and the other of the CSIs, the new CSI will be able to apply a warm start to the connection, because it has been primed with recent references and data segments. Thus, data reduction can immediately begin at an effective level.

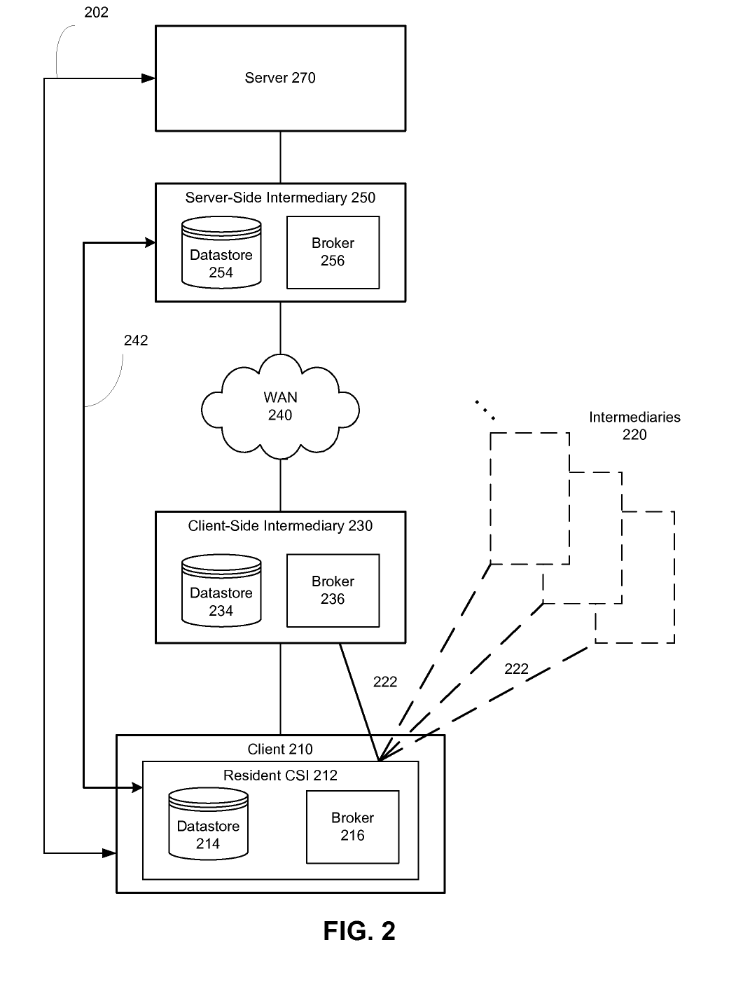

FIG. 2 is a block diagram demonstrating the sharing of optimization information between network intermediaries, according to some embodiments of the invention.

When an optimizable client-server communication connection is established, the responsible client-side network intermediary establishes an optimization channel with a server-side network intermediary. This channel is used to convey the client-server communications in optimized form. Separate local channels, or branch channels, are established between the responsible CSI and one or more peer CSIs. These channels are used to share the optimization information between peer intermediaries.

In FIG. 2, resident CSI 212 of client 210 has established client-server connection 202 with server 270. Connection 202 comprises optimization channel 242 between resident CSI 212 and SSI 250, through which the client-server communications pass in optimized form across WAN 240.

Branch channels 222 are established between the resident CSI and peer client-side intermediaries that will be warmed with optimization information associated with channel 242. Branch channels 222 are established at least with CSI 230, but may also be established with one or more additional network intermediaries 220, which may comprise resident and/or non-resident CSIs.

Each intermediary comprises a datastore (214, 234, 254) and/or other storage for storing references used during data reduction, data segments corresponding to the references, other optimization information, identities of peer and/or partner intermediaries, etc. To warm its peers, resident CSI 212 shares with intermediaries 220, 230 references received from SSI 250 via channel 242 and new references it generates and sends to SSI 250.

The peer intermediaries may simply acknowledge references received from resident CSI 212 that they already possess in their datastores. But if a peer receives a reference not already in its datastore, it may request the corresponding data segment from resident CSI 212, either immediately or when it is needed. For example, if the peer later receives the same reference via a different optimization channel with SSI 250, it may request the segment at that time (instead of requesting it from the SSI and incurring additional network latency).

Server-side intermediary 250 and the peer client-side intermediaries will maintain a record of the peer relationship. Therefore, the SSI knows that, during data reduction optimization with any of the peers, it can use any reference that any of the peers possesses. If the recipient of that reference does not possess the data segment, it can retrieve it from a peer with less latency than would be incurred in retrieving it from the SSI.

Each intermediary comprises a broker (216, 236, 256) to determine when to request a segment from a peer. In some embodiments of the invention, a broker may first attempt to resolve a reference locally (i.e., within the intermediary's own datastore), and then refer to one or more peers if not found in the local datastore. If no peer can resolve the reference, the broker may initiate a request to the server-side intermediary.

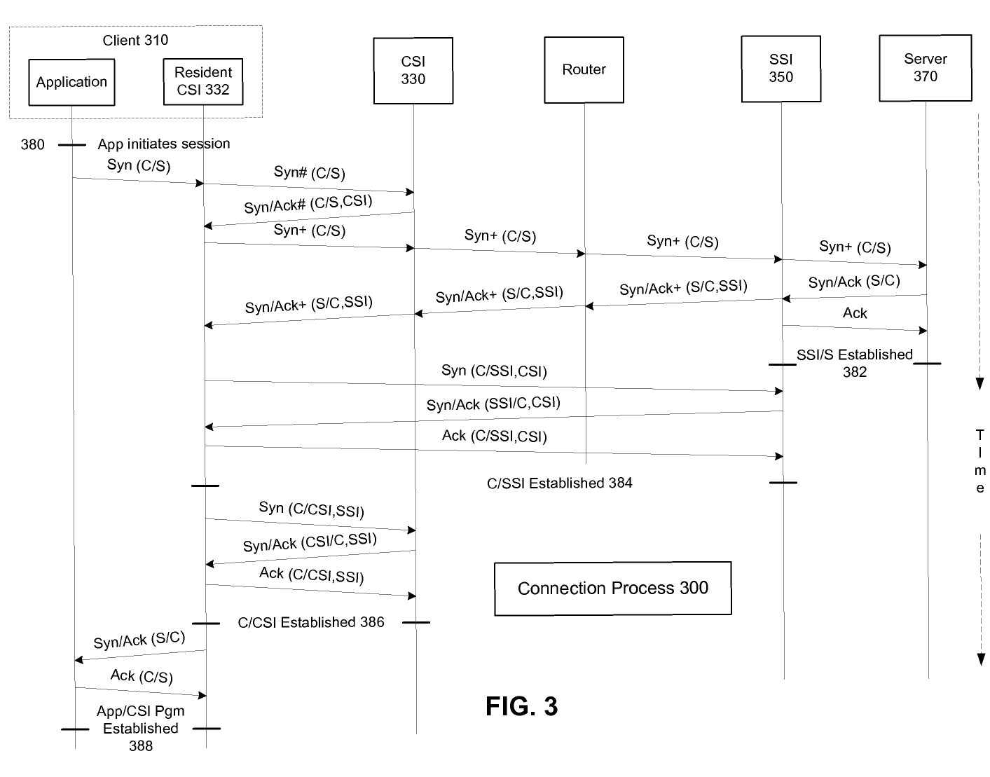

FIG. 3 is a time sequence diagram demonstrating a handshaking process for establishing a client-server communication connection in which a network intermediary not participating in the connection can be warmed, according to some embodiments of the invention.

In these embodiments, client 310 communicates with server 370 through one or more client-server connections active at different times. Transactions (e.g., messages) exchanged via the connections are optimized through different pairs of network intermediaries (e.g., two or more proxy pairs) at those different times.

For example, at one time, one client-server communication connection established between client 310 and server 370 may employ CSI 330 and SSI 350 for optimization. At some other time, another client-server communication connection may employ resident client-side intermediary 332 and server-side intermediary 350 for optimization, where resident CSI 332 resides on client 310.

Because the client-side intermediaries share optimization data (e.g., references, data segments) for warming purposes, when the client transitions from the first connection to the second connection, resident CSI 332 can provide substantially the same level of optimization that CSI 330 had provided. In particular, there is no “cold start” during which the resident CSI must learn the references and data segments and develop the necessary optimization information and metadata.

Although only two alternative intermediary pairs are represented in FIG. 3, in other embodiments of the invention additional pairs may be supported, wherein optimization data is shared among a corresponding number of intermediaries. In yet other embodiments of the invention, optimization data may be shared between communication connections involving different clients and/or different servers.

Also, although client 310 is depicted as the communicant that may change physical or logical location (i.e., to use a different client-side intermediary for optimization), in other embodiments, server 370 may change location; in this case, multiple server-side intermediaries would be employed instead of (or in addition to) multiple client-side intermediaries.

Connection process 300 of FIG. 3 is performed to ensure the client-side intermediaries discover a server-side intermediary that can help optimize connections with server 370. A similar process may be initiated whenever a client or CSI attempts to open a connection with a server with which it does not already have a connection.

In FIG. 3, at time 380, an application residing on client 310 initiates a client-server connection with server 370. This may involve issuing a SYN message identifying the client and the target server/service.

Resident CSI 332 intercepts the connection request and attempts to identify the first or nearest network intermediary, other than itself, on a path toward the server. Illustratively, this action is taken to determine whether the client is currently operating behind another CSI.

For example, if the client is presently operating within a branch office or other location that is coupled to a network of the organization that operates server 370, there may be a more robust or centralized CSI in that location to support optimization. If so, the resident CSI may yield or defer optimization of a client communication connection to the branch CSI. Conversely, if there is no other client-side intermediary available, or no other suitable client-side intermediary, the resident CSI knows that it will have to perform optimization on behalf of the client.

In the illustrated embodiments of the invention, discovery of the first network intermediary begins with a SYN# message issued toward the target server/service. The “#” portion of the SYN# message indicates that the message comprises a special element, such as a particular TCP (Transmission Control Protocol) option, that will be understood by another network intermediary as an attempt to locate the first network intermediary. When an intermediary such as CSI 330 receives the SYN# message, it consumes the message and responds with a SYN/ACK# message that acknowledges the SYN# and that identifies the intermediary.

Resident CSI 332 may now determine whether the responding network intermediary is “local” or otherwise capable as acting as a CSI for a connection between client 310 and server 370. For example, if the latency of SYN/ACK# message is below a threshold (thereby indicating that the sender is very close), or if the responding CSI's identity matches an identity of an intermediary known to be capable of operating as a CSI in the client's present location, the resident CSI will accept the responding intermediary as a CSI. In other embodiments of the invention, other means may be used to identify a network intermediary as being (or not being) local.

When both a local CSI and a resident CSI are available for optimizing a client-server connection, either may be used (in conjunction with the SSI), based on any suitable policy or criteria. Whichever is not used may be warmed.

Now the resident CSI issues another special SYN message, shown as SYN+ in FIG. 3, to identify the network intermediary closest to the target server/service. The SYN+ message comprises another special element that will cause network intermediaries to forward the message toward the specified destination (i.e., server 370) instead of consuming it. Other network nodes, such as a router or switch, may simply treat the SYN+ (or SYN#) message as a regular SYN message and forward it toward its destination.

Eventually, the SYN+ message is consumed by the server, which then issues a regular SYN/ACK identifying itself and the client. The network intermediary closest to the server will receive and consume the regular SYN/ACK. The SSI recognizes the SYN/ACK as corresponding to the preceding SYN+ message (e.g., based on the client/server addresses), and determines that, logically, it is the closest server-side intermediary, and should support the client-server connection for optimization and/or other purposes.

Therefore, SSI 350 dispatches a special SYN/ACK+ message toward client 310 to further the client-server connection and to identify itself SSI 350 also responds to the server with an ACK message to acknowledge the server's SYN/ACK message. Thus, at time 382, a server portion of the client-server connection between the SSI and server 370 is established.

When resident CSI 332 receives the server-side intermediary's SYN/ACK+ message, it proceeds to create a channel between itself and the SSI, which is established at time 384. In doing so, the resident CSI may identify CSI 330 to the SSI, so that the SSI knows that optimization data will be shared with the CSI (e.g., for warming purposes). The SSI may therefore note that resident CSI 332 and CSI 230 are peers, and a data reference sent to one of them can be assumed to be locally available to the other.

Resident CSI 332 also creates a branch channel with CSI 330, which is established at time 386. In creating this channel, the resident CSI may identify SSI 350 to the CSI so that the CSI is also aware of that it is being warmed with optimization information involving the SSI.

Finally, the resident CSI and the application exchange SYN/ACK and ACK messages to establish the client portion of the client-server connection at time 388.

The client-server communication connection formed via connection process 300 may be considered “split-terminated” because it comprises multiple separate sessions—between the application and the resident CSI, between the resident CSI and the SSI, and between the SSI and the server. In this case, the resident CSI will perform optimization (instead of the local CSI).

If the local CSI (CSI 330 in FIG. 3) performs the optimization, then the split-terminated client-server communication connection may be formed from sessions between the client and the CSI, the CSI and the SSI, and the SSI and the server, and connection process 300 would be modified accordingly.

Additional details regarding the creation of a split-terminated client-server connection may be found within U.S. Pat. No. 7,318,100, entitled “Cooperative Proxy Auto-Discovery and Connection Interception” and issued Jan. 8, 2008, which is hereby incorporated by reference for all purposes.

As described above, the channels established in FIG. 3 between (a) resident CSI 332 and SSI 350, and (b) between resident CSI 332 and CSI 330, are used for (a) conducting the client-server connection and optimizing the data, and (b) for warming CSI 330 and resolving references known to one of the peer CSIs but not the other.

Often, multiple communication connections involving any number of different clients and servers will traverse the same pair of network intermediaries. Therefore, in some embodiments of the invention, resident CSI 332 may create separate out-of-band channels with each of CSI 330 and SSI 350, for management, control and/or other purposes. For example, the network intermediaries may use these channels to share information regarding their peers, licensing information, protocol versions, capabilities and so on. Only one of these out-of-band channels is needed between a given pair of intermediaries, regardless of how many optimized channels or branch channels they share.

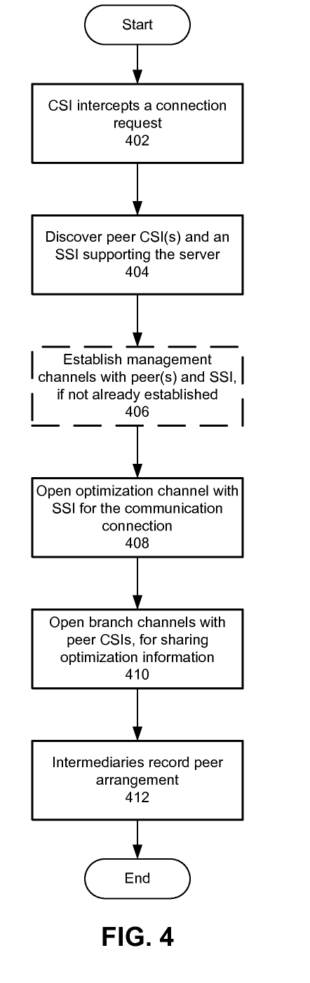

FIG. 4 is a flow chart demonstrating a method of configuring a communication environment to support warming of a network intermediary to enable it to provide an effective level of optimization without a cold start, according to some embodiments of the invention.

In these embodiments, configuration of the environment begins when a request for a communication connection is received by a client-side network intermediary and no warming arrangement has already been established. In other embodiments, an organization may maintain a warming arrangement permanently or semi-permanently, such as in a branch office or other discrete location, in which case less (or no) discovery or handshaking may be needed.

In operation 402, a client-side intermediary intercepts a connection request from a client device or application. In the embodiments of the invention reflected in FIG. 4, the connection request is intercepted by a resident CSI (a CSI that resides on a client device), which proceeds to establish the optimizable connection and to configure the environment for warming one or more peer CSIs. In other embodiments, a non-resident CSI (e.g., a branch office's primary CSI) may perform some or all of these actions.

In operation 404, the resident CSI discovers one or more peer client-side intermediaries, as well as a server-side intermediary that will cooperate with the resident CSI to host the optimized communication connection. As described above in conjunction with FIG. 3, these discoveries may be aided by the use of probes transmitted by the resident CSI. Each probe comprises a TCP packet marked with certain options or fields that will be recognized understood by another network intermediary.

In optional operation 406, the resident CSI opens out-of-band management or auxiliary channels with the SSI and the peer CSIs, if not already established. As described above, these channels may be used for exchanging configuration information, licensing details, intermediary information (e.g., configuration, datastore identifiers), and so on. These channels are not used to host the client-server communication connection or to warm an intermediary. Only one management channel is needed between a given pair of intermediaries, regardless of how many client-server communication connections are being optimized or how many peer intermediaries are being warmed.

In operation 408, the resident CSI opens with the SSI the communication channel that will carry the optimized portion of the client-server communication connection. This channel may or may not be protected with encryption. Contents of the client-server communication connection that traverse this channel may be optimized in various manners, particularly through data reduction.

In operation 410, the resident CSI opens any number of branch channels with the peer CSI or CSIs that will be warmed with optimization information generated or learned via the optimized channel between the resident CSI and the SSI. In some embodiments, the peer client-side intermediaries include at least a central CSI that serves the branch office or other location in which the client device is currently operating. By warming that CSI, the shared optimization information (e.g., references, data segments) may be made available to all other CSIs (including resident CSIs) in that location that have established peer relationships with the central CSI.

In operation 412, some or all intermediaries record details of the peer arrangement, which may include noting which CSIs are peers. The SSI may note which CSIs are participating a peer relationship so that, when sending data to the resident CSI, it can then use any data reference that is known to any of the peers, and the resident CSI can resolve the reference with that peer (if it is unknown).

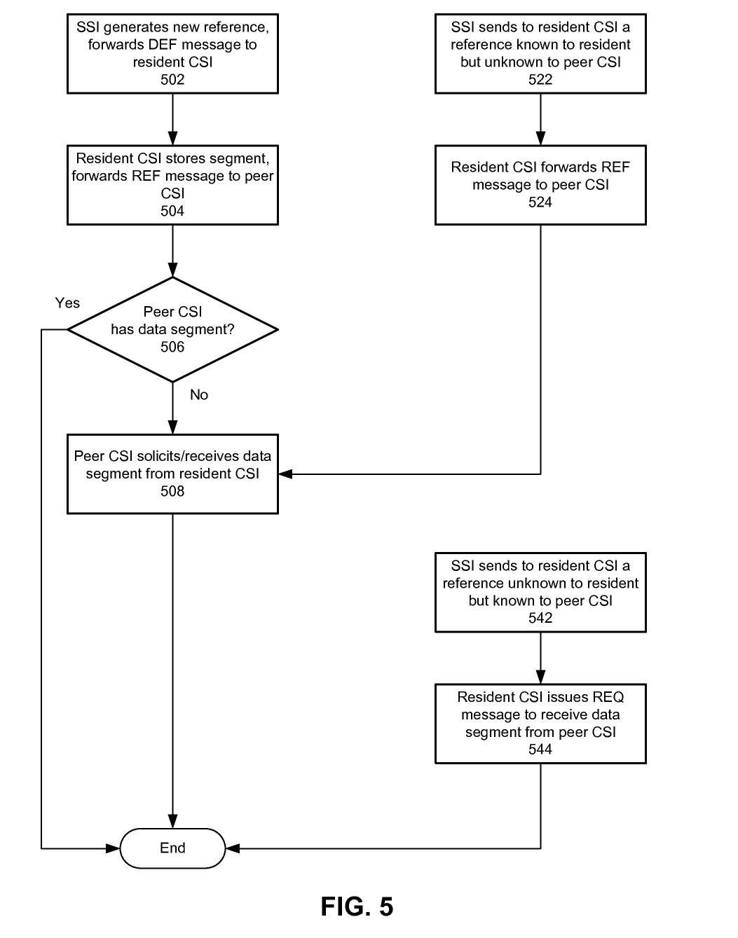

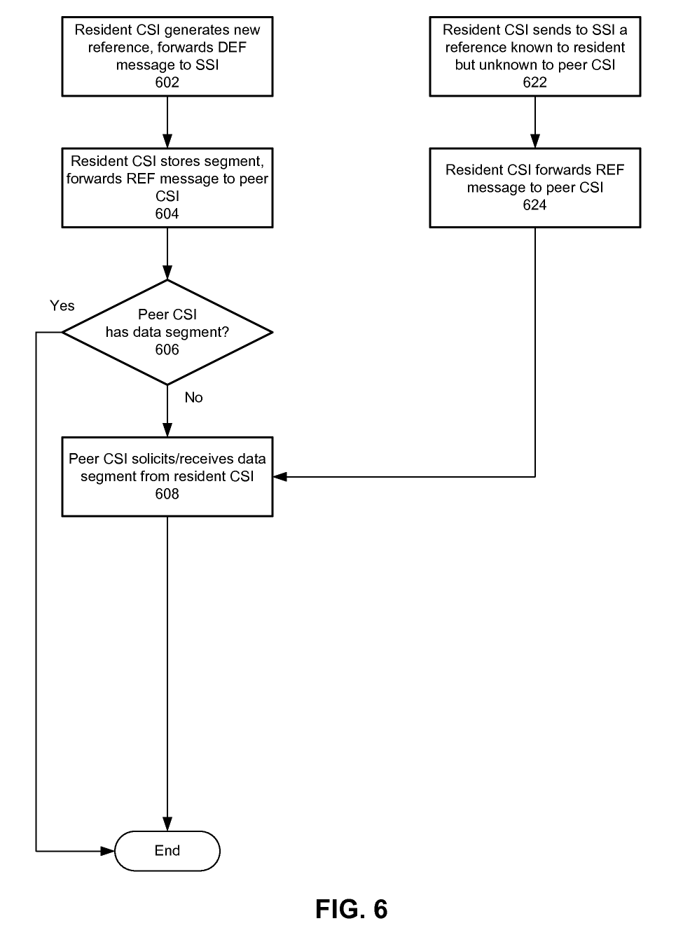

FIGS. 5 and 6 are flow charts demonstrating how a network intermediary may be warmed during optimization of a communication connection, and how a warmed intermediary can be leveraged to reduce the amount of data transmitted across a network, according to some embodiments of the invention. In particular, these figures demonstrate how a peer warming arrangement may be applied during a data reduction scheme to share optimization information (e.g., references, data segments) and resolve unknown references.

In FIG. 5, a resident CSI is cooperating with an SSI to optimize data being downloaded to a client from a server via an optimized client-server communication connection. The resident CSI has opened at least one branch channel with one peer CSI, and warms the peer CSI with optimization information from the client-server connection.

In operation 502, the SSI encounters a data segment for which no reference is known to the SSI, the resident CSI or possibly even the peer CSI. Therefore, the SSI forwards a Definition message to the resident CSI to define a new reference and identify the corresponding data segment.

In operation 504, the resident CSI stores the segment and reference in its datastore and forwards the new reference to the peer CSI in a Reference message. In some embodiments of the invention, the resident CSI may forward to the peer CSI all references it receives from the SSI, or substantially all such references.

In operation 506, the peer CSI determines whether it has the data segment corresponding to the reference forwarded from the resident CSI. If it does not, then in operation 508 the peer CSI issues a Request message to receive it from the resident CSI.

The reference and data segment are now known to the peer CSI and can be used during a separate communication connection that it optimizes, to resolve the reference for another peer, to warm another peer, or even to educate the resident CSI at some later time. For example, the resident CSI may have a limited datastore and may have to purge the data segment before the SSI reuses the reference; at that time the resident CSI may contact the peer to resolve the reference.

In operation 522, the SSI sends the resident CSI a reference that it knows, but that the peer CSI does not know. In operation 524, the resident CSI forwards the reference to the peer CSI. As described above, a CSI engaged in optimization may, by default, send all references it receives via the optimized channel to its peer(s).

The illustrated method then returns to operation 508, where the peer CSI requests and receives the corresponding data segment from the resident CSI. In some embodiments of the invention, if the resident CSI knows that the peer does not have a reference, it may forward the corresponding data segment along with the reference, instead of waiting for the peer to request it.

In operation 542, the SSI sends to the resident CSI a reference that is unknown to the resident CSI, but which is known to the peer CSI. In operation 544, the resident CSI requests and receives the corresponding data segment from the peer, and stores it in its datastore.

As described previously, the SSI may record the relationship between the resident CSI and the peer CSI. Even if the SSI knows that its optimization partner (i.e., the resident CSI) doesn't have a particular reference, if it knows that the peer has it (e.g., because the SSI used that reference in a separate optimized connection with the peer), it can use the reference and allow the resident CSI to resolve the reference locally (i.e., with its peer) instead of sending the data segment across the entire network connection.

In FIG. 6, a resident CSI is cooperating with an SSI to optimize data being uploaded from a client to a server via an optimized client-server communication connection. The resident CSI has opened at least one branch channel with one peer CSI, and warms the peer CSI with optimization information from the client-server connection.

In operation 602, the resident CSI encounters a data segment for which no reference is known to the resident CSI, the SSI and possibly even the peer CSI. Therefore, the resident CSI forwards a Definition message to the SSI define a new reference and identify the corresponding data segment.

In operation 604, the resident CSI stores the segment and reference in its datastore, and forwards the new reference to the peer CSI. In operation 606, the peer CSI determines whether it has the data segment corresponding to the reference forwarded from the resident CSI. If it does not, then in operation 608 the peer CSI requests and receives it from the resident CSI.

In operation 622, the resident CSI sends the SSI a reference that it knows, but that the peer CSI does not know. In operation 624, the resident CSI forwards the reference to the peer CSI. As described above, a CSI engaged in optimization may, by default, send all references it receives via the optimized channel to its peer(s). The illustrated method then returns to operation 608 to allow the peer CSI to request and receive the corresponding data segment from the resident CSI.

In some embodiments of the invention, when an intermediary that is participating in an optimized connection and that is also warming one or more peers receives or generates a new reference, it may automatically send the reference and corresponding data segment to those peers. This differs from embodiments of the invention described above in conjunction with FIGS. 5 and 6, wherein the resident proxy initially sends just the new reference to a peer, and sends the corresponding segment only when the peer requests it.

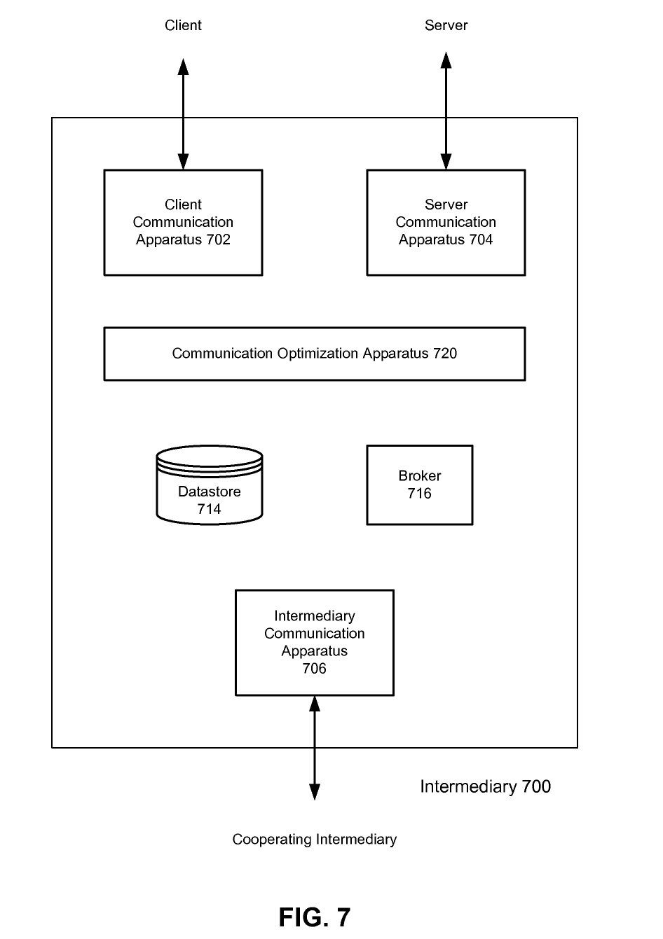

FIG. 7 is a block diagram of hardware apparatus that may be employed to optimize a communication connection and to warm another apparatus to optimize another connection, and/or that may be warmed by the other apparatus when it optimizes the other connection, according to some embodiments of the invention.

Intermediary 700 of FIG. 7 comprises communication apparatuses 702, 704, 706 for communicating with a client, a server and another intermediary, respectively. Depending on an intermediary's role (e.g., as a server-side or client-side intermediary), one or more of the communication apparatuses, and/or other components described below, may be omitted. Further, any or all of these communication apparatuses may be combined or divided in other embodiments of the invention.

The communication apparatuses are adapted to transmit communications to, and receive communications from, the indicated entities. The communication apparatuses may also be adapted to assemble/extract components of a communication, to encrypt/decrypt a communication as needed, establish a peer relationship with another intermediary, etc.

Intermediary 700 comprises datastore 714 for storing data segments and references encountered when a data reduction scheme is exercised to reduce the amount of data sent across a communication connection. During data reduction, references are exchanged with the intermediary with which intermediary 700 is cooperating, in place of the larger data segments.

The intermediary may also include other storage for storing other information. Such information may include, but is not limited to, digital certificates, private cryptographic keys, other encryption/decryption keys, client seeds and/or server seeds used during a handshaking process, etc.

Broker 716 is adapted to resolve a reference received by intermediary 700, perhaps from a cooperating intermediary during optimization of a communication connection. Broker 716 may be configured to first attempt to resolve the reference locally (i.e., at datastore 714). If this fails, the broker may contact one or more peer intermediaries through their corresponding branch channels to try to obtain the corresponding data segment. If no peer possesses the data segment, the broker may request it from the intermediary that sent the reference.

Communication optimization apparatus 720 is adapted to optimize communications exchanged with another intermediary. Thus, apparatus 720 may perform data reduction, may compress (or expand), encrypt (or decrypt), cache or otherwise enhance the efficiency of client-server communications.

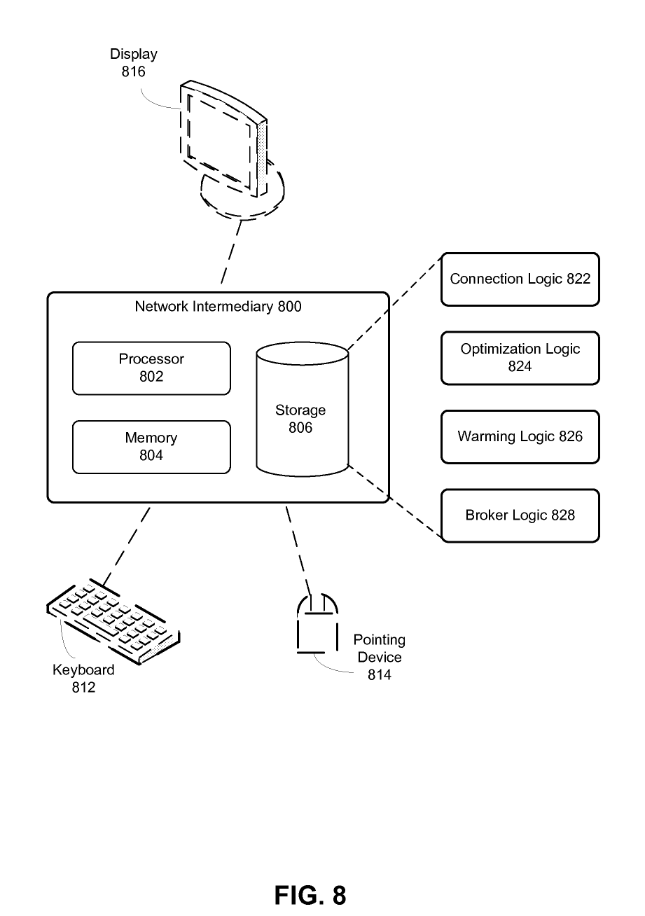

FIG. 8 is a block diagram of a network intermediary that may be employed to facilitate establishment of a secure split-terminated client-server connection with certificate-based authentication of a client, according to some embodiments of the invention.

Network intermediary 800 of FIG. 8 comprises processor 802, memory 804 and storage 806, which may comprise one or more optical and/or magnetic storage components. Network intermediary 800 may be coupled (permanently or transiently) to keyboard 812, pointing device 814 and display 816.

Storage 806 of the network intermediary stores logic that may be loaded into memory 804 for execution by processor 802. Such logic includes connection logic 822, optimization logic 824, warming logic 826, and encryption/decryption logic 528.

Connection logic 822 comprises processor-executable instructions for establishing, maintaining and terminating communication sessions and connections. Such sessions may be with other network intermediaries, with clients and/or with servers.

Optimization logic 824 comprises processor-executable instructions for optimizing a communication. Such optimization may involve replacing all or a portion of the communication with substitute content for transmission to another network intermediary, exchanging substitute content in a communication received from another intermediary for its original content, compressing (or decompressing) content of a communication, performing encryption/decryption, etc.

Warming logic 826 comprises processor-executable instructions for sharing, with another network intermediary, optimization information gleaned from an optimized communication connection. Thus, references generated for or received via the connection may be provided to a peer intermediary, and may be resolved to their corresponding data segments upon request.

Broker logic 828 comprises processor-executable instructions for resolving a reference when intermediary 800 is being warmed by another intermediary, or when intermediary 800 is warming another intermediary. In particular, broker logic ensures the reference is resolved at a peer intermediary when it cannot be resolved locally within intermediary 800. Broker logic 828 may operate as part of optimization logic 824 in some embodiments of the invention.

In embodiments of the invention in which a network intermediary is a resident client-side intermediary program, hardware elements identified above may refer to components of the client device on which the resident CSI executes.

The environment in which a present embodiment of the invention is executed may incorporate a general-purpose computer or a special-purpose device. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of warming a network intermediary device for performing data reduction, the method comprising:
establishing a first communication connection between a first network intermediary and a second network intermediary;
performing data reduction on the first communication connection; and
sharing one or more artifacts of said data reduction with a third network intermediary not participating in the first communication connection.

2. The method of claim 1, further comprising, at the third network intermediary:
establishing a second communication connection with a fourth network intermediary; and
using said shared artifacts to perform data reduction on the second communication connection.

3. The method of claim 2, wherein the fourth network intermediary comprises one of the first network intermediary and the second network intermediary.

4. The method of claim 1, wherein said sharing artifacts comprises:
receiving a first reference at the first network intermediary, from the second network intermediary; and
forwarding the first reference to the third network intermediary.

5. The method of claim 4, wherein said sharing artifacts further comprises:
receiving at the first network intermediary, from the third network intermediary, a request for a data segment corresponding to the first reference; and
forwarding the corresponding data segment to the third network intermediary.

6. The method of claim 5, further comprising, after said forwarding the corresponding data segment:
receiving the first reference at a later time; and
requesting the corresponding data segment from the third network intermediary.

7. The method of claim 1, wherein said sharing artifacts comprises:
at the first network intermediary, generating a new reference to represent a data segment to be communicated to the second network intermediary; and
forwarding the new reference to the third network intermediary.

8. The method of claim 1, wherein said establishing a first communication connection comprises, at the first network intermediary:
receiving from a client a connection request directed toward a server;
discovering a proximate network intermediary on a path toward the server; and
discovering a remote network intermediary on the path toward the server, wherein the remote network intermediary is the second network intermediary;
wherein the first communication connection is established on behalf of the client and the server.

9. The method of claim 8, wherein the third network intermediary is the proximate network intermediary.

10. A computer-readable medium storing instructions that, when executed by a computer, cause the computer to perform a method of warming a network intermediary device for performing data reduction, the method comprising:
establishing a first communication connection between a first network intermediary and a second network intermediary;
performing data reduction on the first communication connection; and
sharing one or more artifacts of said data reduction with a third network intermediary not participating in the first communication connection.

11. A method of warming a network intermediary, the method comprising:
establishing a split-terminated communication connection between a client and a server, wherein the communication connection comprises an optimized communication session between first network intermediary and a second network intermediary;
establishing a branch communication session between the first network intermediary and a third network intermediary not participating in the split-terminated communication connection;
initiating a data reduction scheme on the optimized communication session; and
forwarding to the third network intermediary one or more references exchanged between the first network intermediary and the second network intermediary.

12. The method of claim 11, further comprising:
forwarding to the third network intermediary data segments corresponding to the one or more references.

13. The method of claim 12, further comprising, at the third network intermediary:
using the one or more references during data reduction performed on another optimized communication session.

14. The method of claim 13, wherein the other optimized communication session is conducted between the third network intermediary and one of the first network intermediary and the second network intermediary.

15. The method of claim 11, further comprising, at the first network intermediary:
receiving an unknown reference from the second network intermediary, as part of the data reduction scheme; and
requesting from the third network intermediary a data segment corresponding to the unknown reference.

16. Apparatus for warming a network intermediary from an optimized communication connection in which the network intermediary does not participate, the apparatus comprising:
a first network intermediary and a second network intermediary configured to cooperate to optimize a client-server communication connection, wherein said optimizing includes data reduction;
an optimized communication channel coupling the first network intermediary and the second network intermediary, wherein the optimized communication channel is configured to convey optimized client-server communications; and
a third network intermediary not participating in the communication connection; and
a branch channel coupling the third network intermediary to the first network intermediary, wherein the branch channel is configured to convey to the third network intermediary artifacts of said data reduction.

17. The apparatus of claim 16, wherein said artifacts comprise one or more references exchanged between the first network intermediary and the second network intermediary.

18. The apparatus of claim 17, wherein said artifacts further comprise data segments corresponding to the one or more references.

19. The apparatus of claim 16, further comprising:
a second optimized communication channel established between the third network intermediary and a fourth network intermediary;
wherein said artifacts are used by the third network intermediary during data reduction of communications exchanged via the second optimized communication channel.

20. The apparatus of claim 16, wherein each of the first network intermediary and the third network intermediary comprise:
a datastore configured to store references and data segments; and
a broker configured to resolve a given reference to its corresponding data segment, wherein said broker may interact with a broker of another network intermediary to resolve the given reference if the corresponding data segment is not stored in the datastore.
